(19) United States
(12) Patent Application Publication
(10) Pub. No.: US 2020/0124027 A1
(43) Pub. Date: Apr. 23, 2020

(54) WIND TURBINE WITH AN AUXILIARY POWER SUPPLY

(71) Applicant: Siemens Gamesa Renewable Energy A/S, Brande (DK)

(72) Inventors: Mogens Lund, Videbaek (DK); Peder Mohr Jensen, Fredericia (DK)

(21) Appl. No.: 16/483,607

(22) PCT Filed: Dec. 19, 2017
(86) PCT No.: PCT/EP2017/083454

§ 371 Date: Aug. 5, 2019

(30) Foreign Application Priority Data
Feb. 7, 2017 (DE) 10 2017 201 874.7

(51) Int. Cl. F03D 9/25; H02J 9/06

(52) U.S. Cl. CPC F03D 9/255; H02J 9/067; H02J 9/068

(57) ABSTRACT

Provided is a wind turbine with an auxiliary power supply. The wind turbine includes a generator, a main converter and a transformer. The generator is connected with the main converter. The main converter is connected with the transformer. The transformer is connected with an electrical grid. Thus electrical power with a varying frequency, being produced by the generator, is converted into electrical power with a defined frequency by the main converter and the electrical power with the defined frequency is transformed and provided to the grid by the transformer while the transformation is done in accordance to grid code requirements. An auxiliary power supply, providing auxiliary power, is connected via an auxiliary converter with the transformer, thus the auxiliary power supply is decoupled from the transformer and from the grid by the auxiliary converter.

### CROSS-REFERENCE TO RELATED APPLICATIONS

This application claims priority to PCT Application No. PCT/EP2017/083454, having a filing date of Dec. 19, 2017, which is based on German Application No. 10 2017 201 874.7, having a filing date of Feb. 7, 2017, the entire contents both of which are hereby incorporated by reference.

### FIELD OF TECHNOLOGY

The following relates to a wind turbine with an auxiliary power supply.

### BACKGROUND

Auxiliary power is needed for operating auxiliary equipment or auxiliary circuits of a wind turbine.

Auxiliary power can be used to keep and to guarantee basic functionalities of the wind turbine. The auxiliary power might be used for enabling lubrication of bearings, to guarantee the functionality of warning lights, to heat dedicated components of the wind turbine, to ensure a dehumidification of internal power equipments (like converters), to ensure the communication between the wind turbine and controllers or to ensure communication between wind turbine components, etc.

It is even known to use auxiliary power for grid support. This grid support functionality is limited by the capacity of the respective auxiliary power supply.

It is known to supply a wind turbine with auxiliary power by a Diesel-generator or by other suitable power-sources, if the wind turbine is not connected with a power grid or if the grid shows faults or disturbances, etc.

The Diesel-generator might be placed outside of the tower of a given wind turbine, providing auxiliary power tower to the wind turbine. The respective generator can be optimized in its electrical capacity, size and costs as only one wind turbine needs to be supplied with auxiliary power by the generator. In a wind farm, comprising a set of wind turbines, the number of respective Diesel-generators will sum up to given costs. Maintenance work, which is needed for the resulting number of Diesel-generators, is increased as well. Especially in view to offshore sites it might be very expensive to refuel the number of Diesel-generators within a short time interval and regularly. If the weather is rough, the refuel work might become impossible. Also the refuel process is sensitive for the “Environmental Health and Savety, EHS” regulations.

The Diesel-generator might be placed in a central manner in a given wind farm, thus supplying auxiliary power to a set of wind turbines of the wind farm. The respective generator will have an increased electrical capacity, an increased size and even increased costs as the solution described above. Maintenance work, which is needed for this Diesel-generator, will be decreased as only one Diesel-generator is addressed. Especially in view to offshore sites it is very expensive to refuel the Diesel-generator of the wind farm at short time interval. If the weather is too rough, the refuel work might become impossible as well. Even the refuel process is a very high issue in view to “Environmental Health and Savety, EHS” regulations.

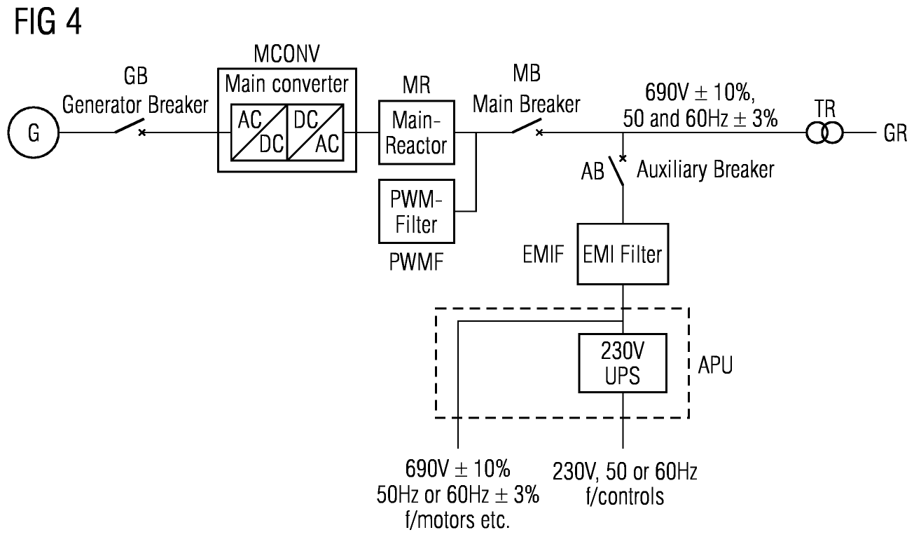

FIG. 4 shows a wind turbine with an auxiliary power supply according to the prior art known and in a principle manner.

A wind turbine generator G is coupled via a generator breaker GB to a main converter MCONV.

The generator G generates electrical power based on the wind, acting on wind turbine blades. The electrical power shows a variable frequency.

The main converter MCONV comprises an AC/DC converting part and a DC/AC converting part. The main converter MCONV converts the electrical power provided by the generator G into electrical power with a defined frequency.

The main converter MCONV might be connected via a main reactor MR with a main breaker MB.

The main reactor MR is used to filter and to influence the electrical power provided by the main converter MCONV.

A PWM-filter PWMF might be arranged in parallel connection to the main reactor MR. This filter is shown for information only.

The main breaker MB is connected with a transformer TR of the wind turbine. The main breaker MB is open if a fault is detected in the components between the main breaker MB and the generator G.

The main breaker MB is closed if the wind turbine is in operation or if the wind turbine is going to prepare its operation.

The transformer TR of the wind turbine is connected via a medium or high voltage breaker (not shown in detail) with the grid GR.

The transformer TR transforms the electrical power into a grid-compliant electrical power, which shows a defined voltage and a defined frequency with a given and allowed deviation.

The main converter MCONV and the main reactor MR might provide an output voltage of 690 V with an allowed deviation of e.g. ±10% and showing a frequency of 50 Hz or 60 Hz with an allowed deviation of e.g. ±3% as input for the transformer TR.

The grid GR can be a wind farm internal grid. It can even be an external power grid of a grid operator.

An auxiliary power unit APU is even coupled via an auxiliary breaker AB and via an EMI-filter EMIF (optional) to the grid G via the transformer TR.

The auxiliary breaker AB is acting as overload and short-circuit-protection of the auxiliary power unit APU.

The auxiliary breaker AB will open automatically in case of overload or in case of a short circuit in the auxiliary power unit APU.

The auxiliary breaker AB might be opened manually in case of servicing the auxiliary-components.

The auxiliary power unit APU comprises one or more auxiliary power sources. As shown the auxiliary power unit APU comprises an uninterruptible power supply UPS, which provides electrical auxiliary power if needed.

The uninterruptible power supply UPS preferably comprises a set of batteries or a capacitor bank or the like, designed for finally providing a voltage of 230 V showing 50 Hz or 60 Hz by the uninterruptible power supply UPS.

The EMI filter EMIF, which is an optional component, is used to filter the auxiliary power, which is provided from the grid GR via the transformer TR and to the auxiliary power unit APU.

The auxiliary power unit APU is charged directly by electrical power being present between the main breaker MB and the transformer TR. Thus power from the grid GR is provided via the transformer TR, the auxiliary breaker AB and the EMI-filter EMIF to the auxiliary power unit APU.

As shown by the supply line within the dashed box of the auxiliary power unit APU the power received from the grid GR is passed on to a motor (i.e. pitch motor, fan motor, pump motor) of the wind turbine. Due to the direct supply the power for the motor shows a voltage of 690 V (in this specific case, it may also be another voltage) with an allowed deviation of e.g. ±10% and a frequency of 50 Hz or 60 Hz with an allowed deviation of e.g. ±3%.

As shown the grid GR and the (auxiliary-) electronic equipment (i.e. the auxiliary breaker AB, the filter EMIF, the uninterruptible power supply UPS, the motor(s) and the control(s) being supplied) are somehow “hardwired” together.

It has to be noted that the motor (pitch motor, fan motor, pump motor) or corresponding other equipment need to be designed in accordance to international standards and/or local standards, showing maximum tolerances.

Due to the hardwiring the desired voltage and frequency of the (auxiliary-) electronic equipment needs to go hand in hand with the voltage and the frequency provided from the grid GR via the transformer TR. Thus there is a kind of limitation in the system architecture.

This results in some unwanted restrictions on voltage and frequency provided from the main converter MCONV to the grid GR.

Auxiliary power can be supplied from the uninterruptible power supply UPS of the auxiliary power unit APU to 230V-components (i.e. control units of the wind turbine, etc.) as well if needed. This auxiliary power will show a voltage of 230 V and 50 Hz or 60 Hz accordingly.

### SUMMARY

An aspect relates to an improved wind turbine with an auxiliary power supply, reducing or even avoiding the problems addressed above.

According to the embodiments of the invention a wind turbine comprises an auxiliary power supply. The wind turbine further comprises a generator, a main converter and a transformer. The generator is connected with the main converter. The main converter is connected with the transformer. The transformer is connected with an electrical grid. Thus electrical power with a varying frequency, being produced by the generator, is converted into electrical power with a defined frequency by the main converter and the electrical power with the defined frequency is transformed and provided to the grid by the transformer. The transformation is done in accordance to grid code requirements. An auxiliary power supply, providing auxiliary power, is connected via an auxiliary converter with the transformer, thus the auxiliary power supply is decoupled from the transformer and from the grid by the auxiliary converter.

By implementation of the auxiliary converter between the auxiliary power supply unit and the transformer a “decoupled auxiliary power supply” it achieved. Thus the full potential of a full scale power converter (e.g. an improved reactive power support to the grid, an improved voltage and frequency range) can be utilized.

Due to this decoupling the main converter and the main reactor might provide an output voltage with an extended allowed deviation and showing a frequency with an extended allowed deviation as input for the transformer.

The unwanted restrictions on voltage and frequency in the whole system (as described above by FIG. 4) can be avoided.

It is even possible to run the main converter at a constant higher voltage level, thus the active power capability of the main converter is increased without any redesign (i.e. an increase up to +10% can be achieved).

### BRIEF DESCRIPTION

Some of the embodiments will be described in detail, with reference to the following figures, wherein like designations denote like members, wherein:

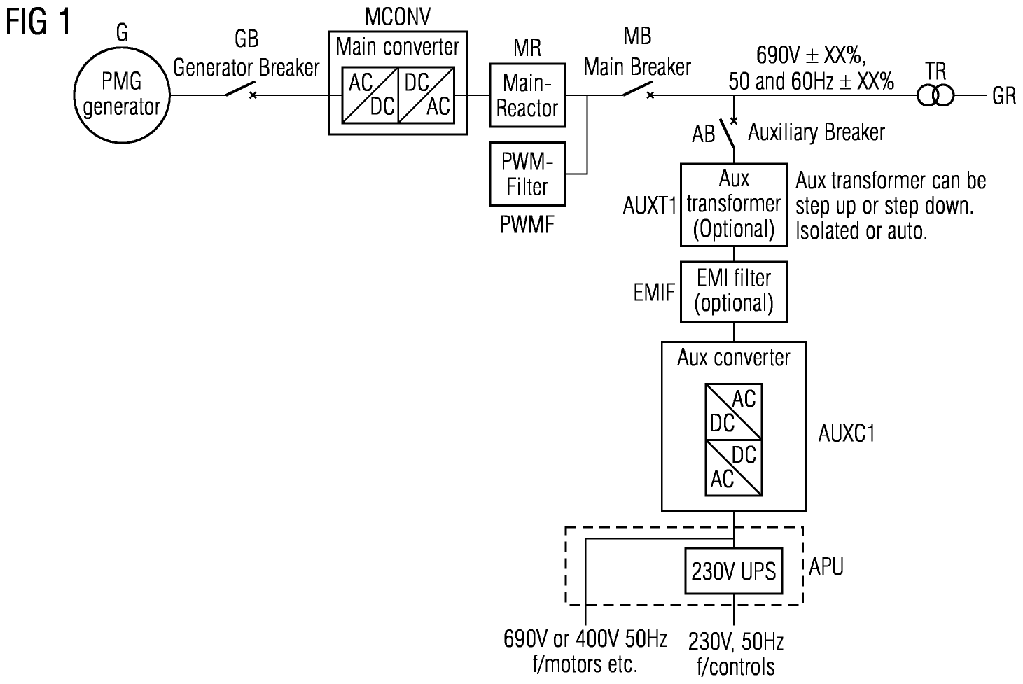

FIG. 1 shows a first embodiment of a wind turbine according to the invention in a principle manner,

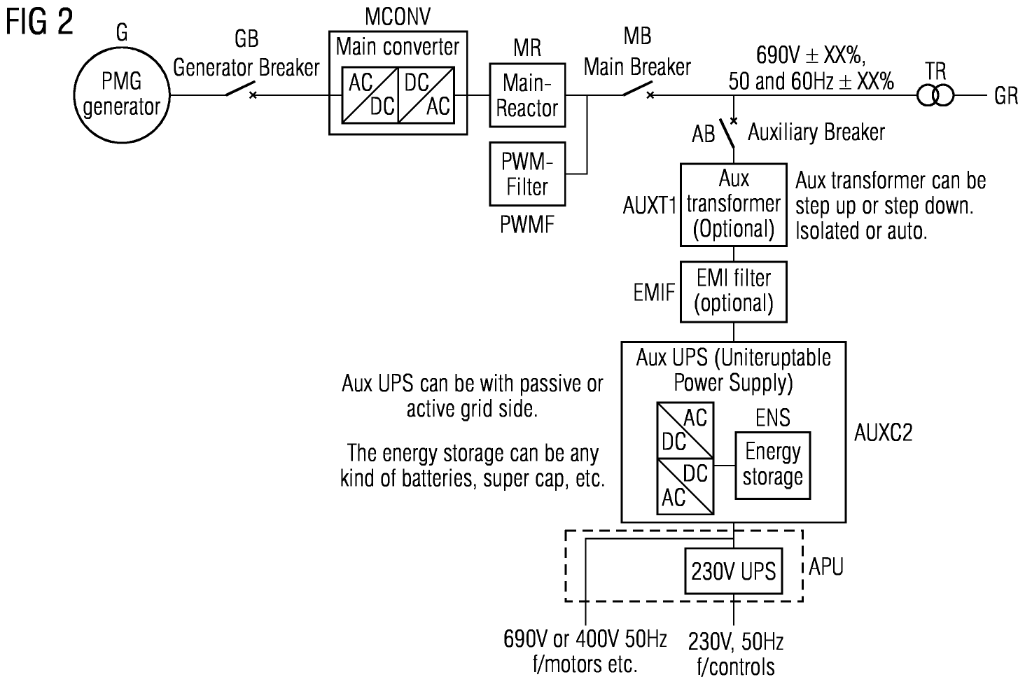

FIG. 2 shows a second embodiment of a wind turbine according to the invention in a principle manner,

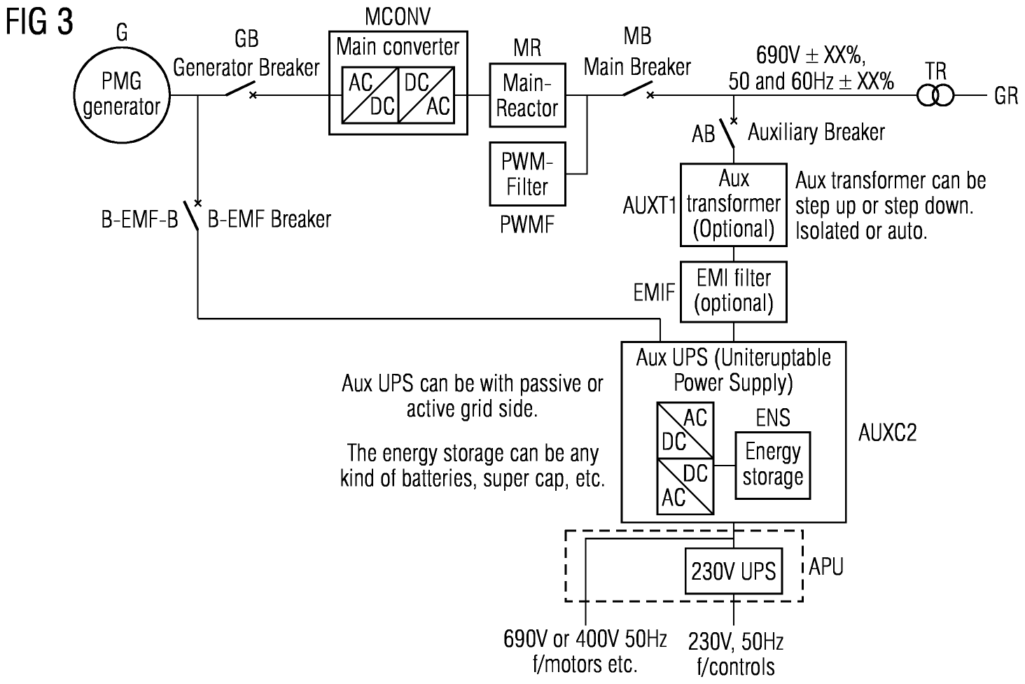

FIG. 3 shows a third embodiment of a wind turbine according to the invention in a principle manner, and

FIG. 4 shows a wind turbine with an auxiliary power supply according to the prior art known as described above in the introduction of this description in a principle manner.

### DETAILED DESCRIPTION

FIG. 1 shows a first embodiment of a wind turbine according to the invention.

For this figure reference is made to the equivalent components and functionalities a shown and described by help of FIG. 4.

According to the embodiments of the invention the auxiliary power supply APU is connected via an auxiliary converter AUXC1 with the auxiliary breaker AB.

Thus the auxiliary power supply APU is electrically decoupled from the auxiliary breaker AB and its subordinate components.

Due to this decoupling the main converter MCONV and the main reactor MR might provide an output voltage of 690 V (in this example, it might be other voltages referring to other manufacturers as well) with an extended allowed deviation of XX % and showing a frequency of 50 Hz or 60 Hz with an extended allowed deviation of +XX % as input for the transformer TR.

Thus the unwanted restrictions on voltage and frequency (as described above) can be avoided.

The auxiliary converter AUXC1 comprises an AC/DC converting part and a subsequent DC/AC converting part.

In a preferred configuration the auxiliary converter AUXC1 is a full-scale power converter.

The auxiliary converter AUXC1 is used to decouple the voltage and frequency dependence between the grid GR and the auxiliary power supply APU.

In a preferred configuration an EMF-filter EMF is arranged between the auxiliary breaker AB and the auxiliary converter AUXC1.

The EMF-filter EMF1 is used to filter harmonics on the grid GR before the auxiliary converter AUXC1.

In a preferred configuration an auxiliary transformer AUXT1 is arranged between the auxiliary breaker AB and the auxiliary converter AUXC1. Thus the auxiliary transformer AUXT1 is optional.

The auxiliary transformer AUXT1 can comprise these functionalities: step up or step down/isolated or auto.

The auxiliary transformer AUXT1 is used to step up or step down the voltage of the grid GR before the auxiliary converter AUXC1.

The generator G is preferably a “Permanent Magnet Generator, PMG”.

FIG. 2 shows a second embodiment of a wind turbine according to the invention.

For this figure reference is made to the equivalent components and functionalities a shown and described by help of FIG. 1 and by help of FIG. 4.

According to the embodiments of the invention the auxiliary power supply APU is connected via an auxiliary converter AUXC2 with the auxiliary breaker AB.

The auxiliary converter AUXC2 comprises an AC/DC converting part and a subsequent DC/AC converting part.

An energy storage ENS is connected with the DC-part of the auxiliary converter AUXC2.

The energy storage ENS can be any kind of batteries, super capacitors, etc.

In a preferred configuration the auxiliary converter AUXC2 is a full-scale power converter.

The energy storage ENS can be used to provide short time energy or power to the auxiliary converter AUXC2.

For a time limited period of time the uninterruptible power supply UPS can stop extracting power from the grid GR or from the configuration “generator G—main converter MCONV”. Thus instead of doing so the power is extracted from the energy storage ENS and is supplied to the auxiliary power supply APU.

If the uninterruptible power supply UPS is equipped and connected with an active grid side it will be possible (for a time limited period) that the uninterruptible power supply UPS stops extracting power from the grid GR or from the configuration “generator G—main converter MCONV”. Instead of this the power might be extracted from the energy storage ENS and might be supplied to the auxiliary power supply APU and to the generator G as well.

For example this might be used for an improved “grid fault ride through, GFRT” capability, for an improved inertia response, for an improved frequency control, for an improved reactive capability or for other ancillary services needed.

The auxiliary converter AUXC2 is acting like an “Uninterruptable Power Supply, UPS” and can operate with an active grid side or with a passive grid side.

FIG. 3 shows a third embodiment of a wind turbine according to the invention.

For this figure reference is made to the equivalent components and functionalities a shown and described by FIG. 2.

According to the embodiments of the invention the auxiliary power supply APU is connected via the auxiliary converter AUXC2 with the auxiliary breaker AB.

The auxiliary converter AUXC2 is additionally connected via a breaker BEMF-B with the generator G and with the generator breaker GB.

In case of a grid failure, a grid fault or in case of a grid disturbance it is possible to open the auxiliary breaker AB and the generator breaker GB.

Next the generator G is brought to a rotational speed, which is between 0 RPM and nominal RPM. Next the breaker B-EMF-B is closed and the auxiliary converter AUXC2 is supplied from the generator G directly.

Thus auxiliary power can be provided to wind turbine components and is used there to keep and to guarantee basic functionalities of the wind turbine. The auxiliary power might be used for enabling lubrication of bearings, to guarantee the functionality of warning lights, to heat dedicated components of the wind turbine, to ensure a dehumidification of internal power equipments (like converters), to ensure the communication between the wind turbine and controllers or to ensure communication between wind turbine components, etc.

Even a “fast idling” will be enabled. The “fast idling” refers to a method reducing tower-loads, which are caused by waves if the wind turbine is without grid connection. This gives a significant reduction in steel for the tower and foundation.

The advantage of this embodiment is that in case of short term or in case of a long term grid outage the wind turbine is able to produce its own auxiliary power needed and addressed above.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A wind turbine with an auxiliary power supply, the wind turbine comprising:
a generator;
a main converter; and
a transformer;
wherein the generator is connected with the main converter, the main converter is connected with the transformer, the transformer is connected with an electrical grid;
wherein electrical power with a varying frequency is produced by the generator, and is converted into electrical power with a defined frequency by the main converter; the electrical power with the defined frequency being transformed and provided to the electrical grid by the transformer while the transformation is done in accordance to grid code requirements;
wherein the auxiliary power supply, providing auxiliary power, is connected via an auxiliary converter with the transformer, and the auxiliary power supply is decoupled from the transformer and from the electrical grid by the auxiliary converter.

2. The wind turbine according to claim 1, wherein the auxiliary converter comprises a AC/DC converting part and a subsequent DC/AC converting part.

3. The wind turbine according to claim 1, wherein the auxiliary converter is a full-scale power converter.

4. The wind turbine according to claim 2, wherein an energy storage is connected with the DC-part of the auxiliary converter.

5. The wind turbine according to claim 1, wherein the auxiliary converter is connected, via a breaker, with the generator, and auxiliary power is provided to wind turbine components needed for basic functionalities of the wind turbine.

6. The wind turbine according to claim 1, wherein the generator is connected via a generator breaker with the main converter.

7. The wind turbine according to claim 1, wherein the main converter is connected via a main breaker with the transformer.

8. The wind turbine according to claim 7, wherein the main breaker is a high voltage main breaker.

9. The wind turbine according to claim 7, wherein the main converter is connected via the main breaker with the auxiliary converter.

10. The wind turbine according to claim 1, wherein a main reactor is connected between the main converter and a main breaker.

11. The wind turbine according to claim 1, wherein the transformer is connected via a breaker, which is a low voltage breaker, with the electrical grid.

12. The wind turbine according to claim 1, wherein the electrical grid is a wind farm internal grid or a power supply grid of a grid operator.

13. The turbine according to claim 7, wherein the main breaker is connected via an auxiliary breaker with the auxiliary converter.

14. The wind turbine according to claim 13, wherein an EMI-filter and/or an auxiliary transformer is connected between the auxiliary breaker and the auxiliary converter.

15. The wind turbine according to claim 1, wherein the auxiliary power unit comprises an uninterruptible power supply.
